(19) United States
(12) Patent Application Publication
(10) Pub. No.: US 2011/0258140 A1
(43) Pub. Date: Oct. 20, 2011

(54) RLIF PROGRAM AND PROCESSOR

(76) Inventor: Mark Shemtob, Denville, NJ (US)

(21) Appl. No.: 13/168,939

(22) Filed: Jun. 25, 2011

Related U.S. Application Data
(60) Provisional application No. 61/403,167, filed on Sep. 11, 2010.

(51) Int. Cl. G06Q 40/00

(52) U.S. Cl. 705/36 R

(57) ABSTRACT

A method for creating a program for pooling of longevity risks among investors comprising in any order the following steps, all or part of the steps being performed by, or with the aid of, a computer: creating pools of investors by grouping together investors who select the same investment maturity date; establishing periodic valuation dates for the investors' accounts; investing investors' funds in the investment portfolios, which the investors selected from the investment portfolio choices made available to them under the program; determining the value of the investors' accounts on the valuation date according to a predetermined formula; and, distributing their account value to the investors who, as of said valuation date, have met the requirements of a predetermined maturity date rule.

### CROSS-REFERENCE TO RELATED APPLICATIONS

This application claims the benefit of U.S. Provisional Application No. 61/403,167, filed Sep. 11, 2010, which is hereby incorporated by reference, to the extent that it is not conflicting with the present application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates generally to the field of financial services and particularly to methods for risk pooling.

2. Description of the Related Art

There are several well known methods for risk pooling, some of which are currently used by the financial services industry. However, there is a need for a method that pools longevity risks on an actuarially fair basis and for an investment program that provides longevity protection without the danger of insurer default.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment a method for pooling longevity risks on an actuarially fair basis is provided. In another embodiment, a method is provided for the creation of an investment program which combines self insurance techniques with notational account concepts. Thus, an advantage is that the program provides longevity protection without the risk of insurer default.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 is a flow diagram illustrating informational flow of the system and method of pooling longevity risks among investors, according to one embodiment.

FIG. 2 is a flow diagram illustrating operational flow of the method of pooling longevity risks among investors, according to one embodiment.

FIG. 3 is a diagram illustrating an exemplary computer system of the method of pooling longevity risks among investors, according to one embodiment.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

Furthermore, various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. It is to be understood that embodiments may be practiced as steps, some of which may be implemented through use of computer systems. Embodiments may be implemented as a computer process, a computer system or as an article of manufacture such as a computer program product. The computer program product may be computer storage medium readable by a computer system and encoding a computer program of instructions for executing a computer process. The computer program product may also be a propagated signal on a carrier readable by a computing system and encoding a computer program of instructions for executing a computer process.

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (a) as a sequence of computer implemented steps running on a computing system and/or (b) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

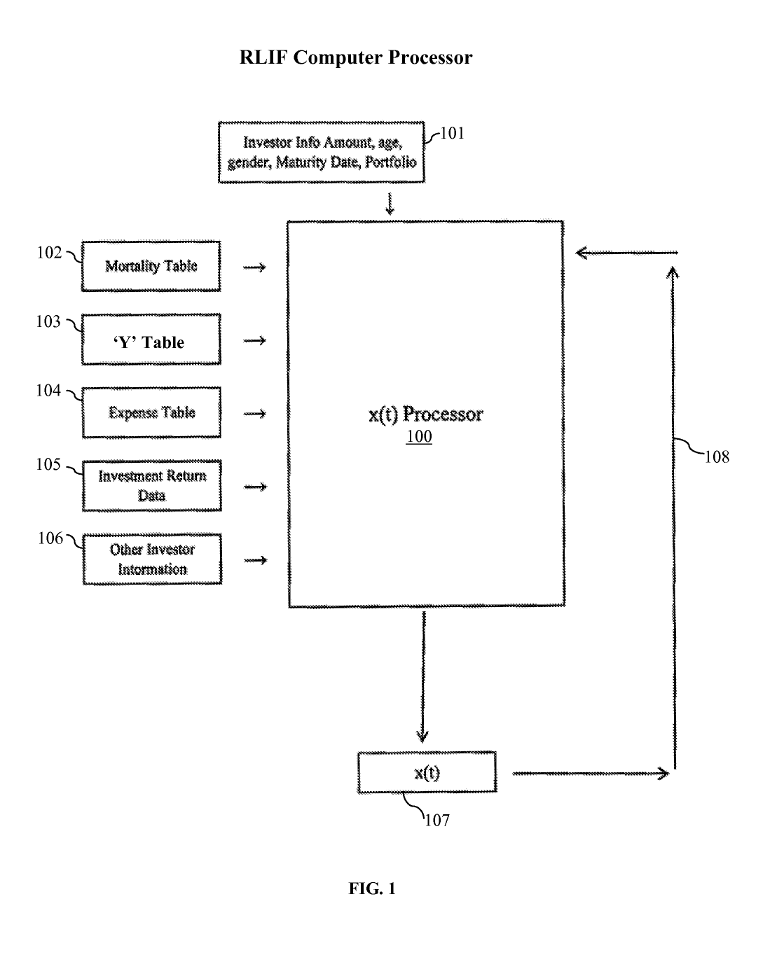

FIG. 1 is a flow diagram illustrating informational flow of the system and method of pooling longevity risks among investors, according to one embodiment. While, for simplification purposes, only a processor 100 is depicted in FIG. 1, it should be understood that, in a practical implementation of the invention, other computer modules such as data entry, storage or display modules may be needed. In order for the processor 100 to calculate an investor's benefit X(t), at a predetermined valuation date, the first input group 101 may include the following inputs: investor info (e.g., name and address), amount invested, age of investor, gender, maturity date, and investment portfolio selected by investor. The amount of the investment is an important factor in determining the value of the benefit the investor will be entitled to at a certain valuation date as explained in more details below. The age and gender of the investor are also important factors. They are used to determine the mortality rate (i.e., probability of death) of the investor using standard set of sex distinct mortality tables 102. The maturity date selected by the investor is an important factor as well. The later the maturity date, the greater the risk assumed by the investor but also the benefit to the investor, if the investor's survives the maturity date selected. The maturity date may also be used to determine the cohorts (pools) for allocation of mortality and other credits.

Investor is also given the opportunity to select an investment portfolio from the investment options offered by the investment fund. This choice gives additional control to the investor over his/her investment risk and potential rewards. For example, a more conservative investor may choose safer but less rewarding investment vehicles such as treasury bonds. Investment portfolio choices may also be used to form or determine cohorts, by, for example, grouping together investors with the same portfolio choices.

The next inputs are the mortality table 102, the Y table 103, the expense table 104, the investment return data 105 and other investors' information 106. Again, the mortality tables 102 are standard set of sex distinct mortality tables and they are used to determine investor's probability of death based on the investor's age and gender. The Y table 103 will contain information regarding the percentages that are going to be taken from investors' accounts that elected to accelerate their maturity dates. The Y table percentages may preferably be based on the age and gender of the investor and the number of years the maturity date is accelerated. By way of example, the age and gender of the investor may be used to determine, using standard gender distinct mortality table, the probability that the investor would have not survived from current age to original maturity date. Next, an acceleration factor, directly related to the number of years of acceleration, may be applied to that probability. For example, let's say that a 70 year old male had an original maturity date that was still 15 years away. First, from the mortality table, it may be determined what the probability of him surviving to age 85 is. Let's say that is 70%. Thus, the probability of him not surviving is 30%. If the acceleration factor is, for example, 0.1, because, let's say, that this investor wants to accelerate his maturity date with 5 years, the percentage from table Y for this investor would be 3% (i.e., 30%×0.1). How high the acceleration factor is, in correlation with the number of years of acceleration, may have to be based on considerations such as program sustainability and marketability. For example, the acceleration factor may be as high as possible without discouraging use of the program by the investors.

In order to encourage investors to use this financial tool and program, there may be the option to get out before their initially elected maturity date. However, if an investor makes this election, her account will be decreased by all prior mortality credits and prior maturity date acceleration credits, plus any investment gains on those assets since the time they were awarded in the past, as well as an additional charge calculated by applying the percentage determined from table Y to the balance of investor's account after deduction of the above credits (i.e., prior mortality credits, prior maturity date credits, and investment gains on those credits). These funds taken from the accelerating investors get credited to the other investors in the pool.

The expense table 104 will contain information about the administrative expenses of the investment fund charged to the investors' accounts during period “t”. Such expenses will be deducted from the investors' accounts. The investment return data 105 represents actual investment returns of the portfolios available under the program during period “t”. Gains will be added and losses will be deducted to/from investors' accounts. Finally, the other investors' information will include the amount of investment, investment portfolios selected, ages, genders, maturity dates selected, and incidence details regarding change of maturity date with respect to additional investors in the pool.

The processor will use the available information to calculate, on a periodic basis, and thus, at a predetermined valuation date, for all investors who have not deceased since the last valuation date, their new notational account value X (t), using the following formula: X (t)=X (t-1)+I (t)+M (t)+Z (t)−E (t)−P (t), wherein:

X (t-1) represents the account value at the prior valuation date. There is one exception: when the account value is calculated for the first time (at first valuation date), X (t-1) will be equal with the amount invested by the respective investor.

I (t) represents the investment gains or losses during period “t” earned by the investment portfolio selected.

M (t) represents the mortality credit earned during period “t”. Such credit shall not be earned by investors who have accelerated their maturity date at any time. The mortality credit is the amount added to the account of an investor who did not die during period “t”, the amount being a portion of the value of the accounts of the investors who did die during period “t”, as it will be explained in more details later.

Z (t) represents maturity date acceleration credits attributable to investor during period “t”, the credits being, as it will be explained in more details later, a portion of the charges to investors' who elected to accelerate their maturity dates (i.e., P (t); see below). Such credits shall not be earned by investors who have accelerated their maturity dates at any time.

E (t) represents administrative expenses charged to the investor's account during period “t”.

P (t) represents maturity date acceleration charges to an investor's account during period “t” attributable to the investor's election to accelerate his or her maturity date should such election be made during period “t”.

It is to be noted that, the length of the period ‘t’ (e.g., one year), which will be the basis of the periodic valuation of the accounts, may be established preferably at the beginning of the program. The first day of each period T, may be preferably be the valuation date ‘v’ for the prior period ‘t-1’. This rule may also be established preferably at the start of the program.

The account value X (t) calculated by the processor 100 will be used to pay the investor(s) whose selected maturity date coincides with the valuation date and survive to said maturity date. For all investors whose maturity date is later, the account value X (t) may be recorded or stored in a storage device 107 and transmitted 108 back to the processor 100 during next valuation at the end of next valuation period to be used in the formula described above. The current X (t) will be X (t-1) in the formula of next valuation date.

It should also be understood that all inputs described above may be preferably entered once and stored in a storage device accessible by the processor 100. Thereafter, the input data may be updated as necessary. Furthermore, display and/or printer devices may be used to transform the input data and the output data (e.g., the investor's info and his/her X (t)) in visually accessible formats.

Again, the program of pooling longevity risks among investors is configured to allow each investor to elect the following: the amount of investment, the maturity date (i.e., the date that investor must survive in order to receive any benefits) and the investment vehicles (from the available options under the program) the investor wishes to have in his portfolio. It is to be noted that the investment funds are closed. After the investor elects how much to invest, and the fund is started, no follow up investments are allowed. However, new funds may be started periodically.

The amount of investment is invested in accordance with the elected investment portfolio with the other program investors. Preferably, the investor may be allowed to request a change in the elected investment portfolio no later than 30 days before any valuation date.

Effective as of such valuation date, the I (t) calculations (i.e., investment gain or losses) in the X (t) formula shall be based upon the performance of that newly elected portfolio.

On a periodic basis, on valuation date, all investors who have not deceased since the last valuation date shall have a new notational account value determined by the processor 100 using X (t) formula described earlier.

The total mortality credit M should be determined by cohorts (i.e., investors with the same original maturity date) and should be equal to the sum of X (t-1) attributable to all those investors that deceased during period “t”. The total maturity date acceleration credit Z should also be determined by cohorts (investor with the same maturity date). The total maturity date credit Z should be equal with the sum of all maturity date charges (i.e., P (t) in the X (t) formula above) that were deducted from the accounts of the investors in the cohort who elected to accelerate their maturity date during period ‘t’.

The maturity date charges P (t) should be equal to the sum of all prior mortality credits and prior maturity date acceleration credits, plus investment earnings on those credits, previously credited to accelerating investor, plus a percentage charge applied to the investor's account value X(t) minus the above credits and earnings. As explained earlier, the Y table (103 in FIG. 1) will be used to determine that percentage, based on, preferably, age, gender and the number of years of maturity date acceleration.

M and Z may be allocated among individual investors in their same cohort based upon the following formulas:

M (t)=M×R/ΣR₁₋ₙ, where R=X (t-1)×Pd; this formulas mean that in order to determine the mortality credit M (t) attributable on valuation date to an investor, the total mortality credit of the cohort M should be multiplied with a ratio R/ΣR₁₋ₙ specifically determined for that investor. The ratio R/R₁₋ₙ for each investor may be calculated by first multiplying that investor's account value during the last valuation date (i.e., X (t-1)) with that investor's probability of death (Pd), (i.e., R=X (t-1)×Pd), and then dividing the result by the sum of R for all eligible cohort members (i.e., ΣR₁₋ₙ). In this way, the share of the total mortality credit and investor gets credited to his/her account is directly related to his/her account value (i.e., the amount of money he/she risks) and his/her probability of death. This means that the higher the amount of money the investor risks and the higher his/her probability of death is, and thus, the less likelier it is that he/she will in the end get any benefit, the larger his/her share of the total mortality credit of the cohort. It should be noted that the probability of death (Pd) may be determined at the beginning of the period T based on standard sex distinct mortality tables (MT).

An investor's share Z (t) of the total maturity date credit Z of the cohort may be determined following similar formulas as above:

Z (t)=Z×R/ΣR₁₋ₙ, where, again, R=X (t-1)×Pd as explained above.

As of each valuation date, each investor who has died during period T without reaching his or her maturity date will have their X (t) set to ‘0’ and will no longer be considered in any future computations. On the other hand, as of each valuation date, each surviving investor who has elected that date as his/her maturity date will be paid out an amount equal to X (t).

### EXAMPLE 1

Mr. X invests $10,000 on Jan. 1, 2010 and elects a maturity date of Jan. 1, 2030.

As of Jan. 1, 2011 Mr. X's $10,000 has increased in value to $11,000 attributable to the following:

$825 of investment earnings;

−$25, administrative expenses; and

$200 because other investors with the same maturity date (same cohort) died and X got a share of their investment, calculated as described above.

As of Jan. 1, 2012 Mr. X's account value increases to $11,800 as follows:

$620 investment earnings;

−$20, administrative expenses;

$150 share attributable to death of investor(s) with same maturity date (same cohort); and

$50 share attributable to maturity date charges against investors with same maturity date (same cohort) who elected to accelerate their maturity date.

Let us say that Mr. X dies on Jan. 1, 2012. Since he died before the maturity date he elected (Jan. 1, 2030), his account value of 11,800 becomes part of the cohort's mortality credit M, and thus, it will get shared by other investors in his group who are alive. Consequently, Mr. X account balance is set to zero in this scenario.

Instead, let's say that that Mr. X is still alive and in 2012 he wants to accelerate his maturity date. Assuming that Y table produces a 10% factor to be applied to the portion of his account that does not represent prior M and Z credits. M and Z credits were $400 and assume that amount earned $20 in investment earnings. The total amount to be forfeited will be $420 plus 10% of his current account value decreased by $420.

It should be noted again that when investors die before their maturity dates their money X(t) gets reallocated to the surviving investors in the cohort as mortality credit M(t). In addition, if an investor wants to accelerate her maturity date, and thus, reduce the risk of having her account forfeited at death, she must pay a price P(t), which goes as Z (t) to the other investors who have not accelerated their maturity date.

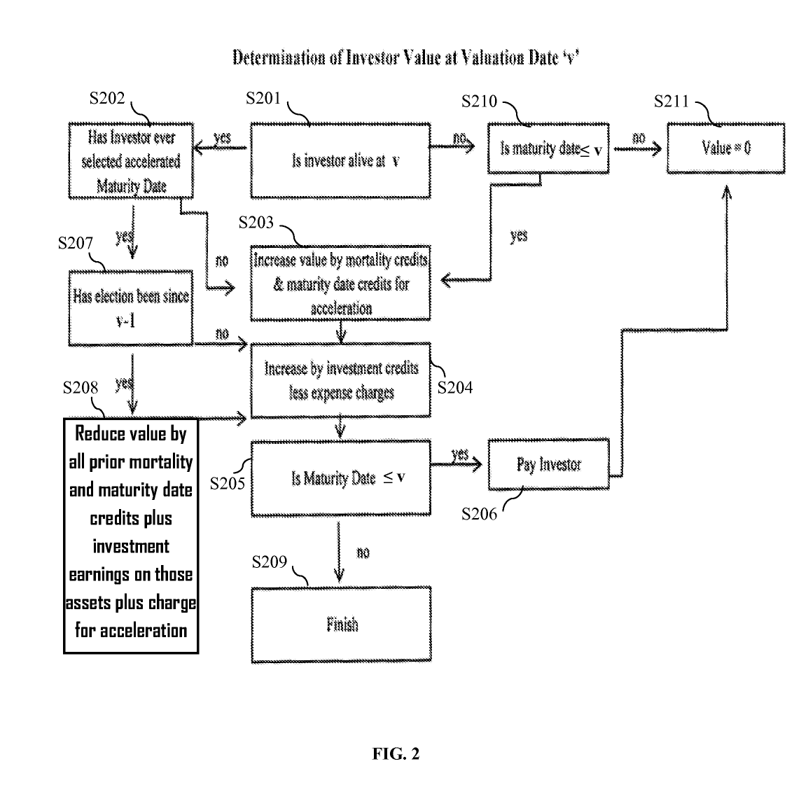

FIG. 2 is a flow diagram illustrating operational flow of the method of pooling longevity risks among investors, according to one embodiment. At valuation date ‘v’, for each investor, the first step S201 is to determine if the investor is alive. If she is alive, then, in step S202, it has to be determined whether or not she ever elected to accelerate her maturity date. If she did not, in step S203, her prior account value (i.e., X(t-1) in the formula described above) is increased by her share of the mortality credit M(t) and her share of the maturity date (acceleration) credits Z(t), both calculated as explained earlier. In step S204, investment gains or losses (i.e., I(t)) and administrative expense charges (i.e., E(t)) are applied to her account to arrive at her current account value (i.e., X(t)) as of that valuation date ‘v’. Next, in step S205, a determination has to be made regarding whether or not her previously selected maturity date falls prior to the valuation date ‘v’ or if it coincides with the valuation date ‘v’. If the answer is yes in either case, the investor is paid in step S206 her account value X(t), and thus, her account balance becomes zero S211. If the answer is no, the process for this investor ends here, S209, and her account value will be carried on to the next period.

If in steps S202 and S207 it is determined that the investor has elected to accelerate her maturity date during period ‘t’(i.e., between prior valuation date ‘v-1’ and current valuation date ‘v’), then, in step 208, her account value will be decreased by all prior mortality credits, maturity date credits and investment earnings on those assets. In addition, this investor will be charged a fee for acceleration (i.e., P(t) in the formula above). From step S208, this investor goes through steps S204-S209 or S204-S206-S211 as described above. It is to be noted that this investor does not receive any mortality credits or maturity date credits for period ‘t’. However, investment gains or losses and administrative expenses for period ‘t’ may still be applied to her account.

If in step S202 and S207 it is determined that the investor has elected to accelerate her maturity date in the past, but not during period ‘t’, then, in step S204, investment gains (or losses) minus her share of the administrative expenses are applied to her account. It is to be noted that this investor also does not receive any mortality or maturity date credits for period T. From step 204, this investor goes through the steps S205-S209 or S205-S206-S211 as described above.

If the investor is not alive on the valuation date ‘v’, what has to be determined in step S210 is whether or not her previously selected maturity date was earlier then or coincides with the valuation date ‘v’. If her maturity date was earlier than the valuation date ‘v’ and she died on or after her maturity date, she will go through steps S203-S204-S205-S206-S211 as described above, meaning that after her new account value X(t) will be calculated, she will be paid her account value, and thus, her account balance will become zero. Similarly, if she is not alive on valuation date ‘v’ but her maturity date coincides with the valuation date and she died on the valuation date, she would also be entitled to her new account value X(t). One of ordinary skills in the art would recognize that alternative maturity date rules may be established under the program without departing from the scope and essence of this invention. For example, such an alternative maturity date rule of the program may provide that if the investor dies prior to her selected maturity date, but within a predetermined time frame, she would still be entitled to her account value. Such predetermined time frame may be 24 hours, 48 hours and so on.

If in steps S201 and S210 it is determined that the investor died without reaching her maturity date, her account is forfeited an it will be distributed to the other investors in the cohort as mortality credits M(t), as described earlier. Thus, this investor's account value becomes also zero in step S211.

It is to be noted that the maturity dates available under the program may preferably coincide with the program's valuation dates. However, maturity dates other than valuation dates may also be permitted.

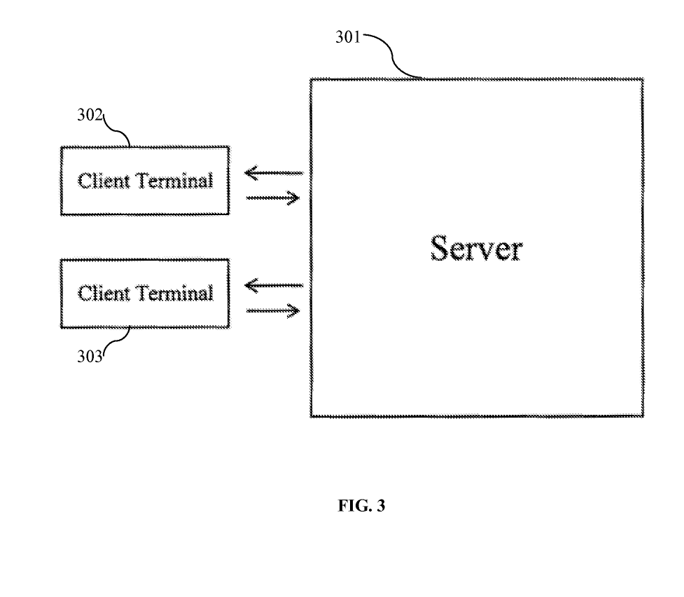

FIG. 3 is a diagram illustrating an exemplary computer system of the method of pooling longevity risks among investors, according to one embodiment. By way of example, the entire program may run on a central server 301, which may be accessed, via the internet for example, by users of computer terminals 302 and 303.

It should also be understood that the invention may be practiced on a computer system comprising a single computer, which may have the common elements, such as input, memory, processing and output devices, or more computers or servers (hereinafter “computer”), which may be connected with each other, and which may be so designed and programmed as to perform the functions pertaining to the invention and described herein. It is to be understood that the term computer is to be understood very broadly, to include, for example, PCs, smart phones, or other similar devices. The computer may be a general purpose computer in which special software, so written as to enable the general purpose computer to perform the functions pertaining to the invention, is installed. The computer may be independent and isolated from other computers, being capable of performing all or part of the said functions without the need of being linked to another computer. For example, the special software, which was initially copied on, for example, a compact disk, may be installed on a general purpose computer, as for example, a PC in an office or at home. That computer may now be capable of performing all or part of the said functions, and therefore, its user may practice the invention.

The computer can also be set, configured, and/or programmed to work in a network environment, as for example, online, via the Internet, or, in a Local Area Network. For example, the special software could be installed on one or more servers which may be accessible through the Internet by a user of a general purpose computer, or any other similar device, capable of connecting to the Internet. Hence, such a user could now practice the invention on his general purpose computer or device.

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A method for creating a program for pooling of longevity risks among investors comprising in any order the following steps, all or part of the steps being performed by, or with the aid of, a computer:
creating pools of investors by grouping together investors who select the same investment maturity date;
establishing periodic valuation dates for the investors' accounts;
investing investors' funds in the investment portfolios, which the investors selected from the investment portfolio choices made available to them under the program;
determining the value of the investors' accounts on the valuation date according to a predetermined first formula;
distributing their account value to the investors who, as of said valuation date, have met the requirements of a predetermined maturity date rule;
for each pool, forfeiting the account value of the investors who, as of said valuation date, have not met the requirements of said maturity date rule; and
distributing the funds of the forfeited accounts from each pool as mortality credits to the other investors in that pool, according to a predetermined second formula.

2. A method as in claim 1 wherein the pools of investors are created by grouping together investors who select the same investment maturity date and who have also selected the same investment portfolio.

3. A method as in claim 1 wherein said first formula comprises adding to an investor's account value of the prior valuation date the gains or losses of her account portfolio for the period between the prior valuation date and the current valuation date, adding any mortality credits attributable to the investor for said period, adding any maturity date acceleration credits attributable to the investor for said period, subtracting the share of the administrative expenses of the program for said period, which is attributable to the investor, and subtracting any maturity date acceleration charge applicable to the investor for said period.

4. A method as in claim 1 wherein the maturity date rule provides that the investor must survive her selected maturity date in order to be entitled to her account value.

5. A method as in claim 1 wherein said second formula comprises multiplying the total mortality credit of the pool with a ratio specifically determined for each investor by first multiplying that investor's account value on the prior valuation date with that investor's probability of death and then dividing the result by the sum of all such results for all eligible pool members.

6. A method as in claim 1 further comprising allowing the investors to accelerate their originally selected maturity date.

7. A method as in claim 6 further comprising applying a maturity date acceleration charge to the value of an investor's account if the investor has accelerated her originally selected maturity date during the period immediately before the valuation date, and distributing the funds resulting from the charge as maturity date acceleration credit to the other investors in the pool who have never accelerated their originally selected maturity date.

8. A method for the periodic determination of the account value of an investor who invests in a longevity risk pooling investment program comprising in any order the following steps, all or part of the steps being performed by, or with the aid of, a computer:
determining the prior account value associated with the prior period;
adjusting the prior account value with the gains or losses of the account portfolio during the current period;
increasing the value of the investor's account by any mortality credits attributable to the investor for the current period;
increasing the value of the investor's account by any maturity date acceleration credits attributable to the investor for the current period;
decreasing the value of the investor's account by the share of the administrative expenses of the program for the current period, which is attributable to the investor; and
decreasing the value of the investor's account by any maturity date acceleration charge applicable to the investor for the current period.

9. A computer system which is so programmed as to be capable of performing in any order the following steps of a method for creating an investment tool for pooling of longevity risks among investors:
creating pools of investors by grouping together investors who select the same investment maturity date;
establishing periodic valuation dates for the investors' accounts;
investing investors' funds in the investment portfolios, which the investors selected from the investment portfolio choices made available to them;
determining the value of the investors' accounts on the valuation date according to a predetermined first formula;
distributing their account value to the investors who, as of said valuation date, have met the requirements of a predetermined mortality date rule;
for each pool, forfeiting the account value of the investors who, as of said valuation date, have not met the requirements of said mortality date rule; and
distributing the funds of the forfeited accounts from each pool as mortality credits to the other investors in that pool, according to a predetermined second formula.

10. A computer system as in claim 9 wherein the pools of investors are created by grouping together investors who select the same investment maturity date and who have also selected the same investment portfolio.

11. A computer system as in claim 9 wherein said first formula comprises adding to an investor's account value of the prior valuation date the gains or losses of her account portfolio for the period between the prior valuation date and the current valuation date, adding any mortality credits attributable to the investor for said period, adding any maturity date acceleration credits attributable to the investor for said period, subtracting the share of the administrative expenses of the program for said period, which is attributable to the investor, and subtracting any maturity date acceleration charge applicable to the investor for said period.

12. A computer system as in claim 9 wherein the maturity date rule provides that the investor must survive her selected maturity date in order to be entitled to her account value.

13. A computer system as in claim 9 wherein said second formula comprises multiplying the total mortality credit of the pool with a ratio specifically determined for each investor by first multiplying that investor's account value on the prior valuation date with that investor's probability of death and then dividing the result by the sum of all such results for all eligible pool members.

14. A computer system as in claim 9 further being programmed to allow the investors to accelerate their originally selected maturity date.

15. A computer system as in claim 14 further being programmed to apply a maturity date acceleration charge to the value of an investor's account if the investor has accelerated her originally selected maturity date during the period immediately before the valuation date, and distributing the funds resulting from the charge as maturity date acceleration credit to the other investors in the pool who have never accelerated their originally selected maturity date.
